(19) United States
(12) Patent Application Publication
(10) Pub. No.: US 2017/0024653 A1
(43) Pub. Date: Jan. 26, 2017

(54) METHOD AND SYSTEM TO OPTIMIZE CUSTOMER SERVICE PROCESSES

(71) Applicant: EdgeVerve Systems Limited, Bangalore (IN)

(72) Inventors: SACHIN NARHARI DESHMUKH, PUNE (IN); MALAY SAURABH PRASAD, PUNE (IN); VENKATA NAGA MAHESHWAR DAMOJIPURAPU, PUNE (IN); NARESHKUMAR MADANLAL KOTHARI, IRVING, TX (US); SANJAY RAMCHANDRAN NAMBIAR, BANGALORE (IN); SHIVAJI BAL APTE, BANGALORE (IN)

(21) Appl. No.: 15/085,939

(22) Filed: Mar. 30, 2016

(30) Foreign Application Priority Data
Mar. 30, 2015 (IN) 1647/CHE/2015

(51) Int. Cl. G06N 5/04

(52) U.S. Cl. CPC G06N 5/046; G06Q 30/016

(57) ABSTRACT

A computer implemented method to optimize system process is disclosed. The received one or more input data is transformed into a predefined format based on transformation rules. The transformed one or more input data is analyzed at an analyzer, based on one or more pre-defined rules associated with a rule engine. A result associated with an inference is generated at the inference generator, from the analyzed one or more input data, based on automation rules. The generated inference may be one of a positive or a negative. When the generated inference is positive, one or more processes associated with the customer service optimization is simulated at the optimization engine, through a graphical processor. The result of the inference generator and the optimization engine are checked against the one or more processes. The result of the inference generator and the optimization engine may be stored at the data repository.

This application claims the benefit of Indian Patent Application Serial No. 1647/CHE/2015, filed Mar. 30, 2015, which is hereby incorporated by reference in its entirety.

### FIELD

This technology generally relates to a field of data processing. In particular, the this technology relates to a method and a system to optimize system processes in a service environment.

### BACKGROUND

Customer service centers are at the cusp of transformation. On one hand, customer experience is important to survive in a customer driven organization and on other hand the ever changing complex process that run on multiple technology platforms restrict the quality of customer support. These issues have diverted the focus of organizations towards automation and touch-less services.

Within an organization, there may be teams working as operation teams to solve tickets logged in a system against names of executives. The teams define a set of processes on work needs to be done to resolve the tickets. The teams are advised to work by following “standard operating procedures” (SOP) defined by the organization. The teams are supposed to speak over the phone with a customer and take action as requested by the customer as per the ticket. In some cases, there could be a computer implemented system to direct computer generated tickets to the teams. During this process the teams are supposed to access various applications and tools to resolve the tickets.

Most of the operation teams are under an assumption that they operate most optimally and there is no room for further optimization. Alternatively, the team is not able to understand if they are working optimally or not. Therefore, there is a need to identify the scope of automation or process optimization.

### SUMMARY

Disclosed are a method, a system and/or an apparatus to optimize system process in a service environment.

In one aspect, a computer implemented method to optimize system process is disclosed. A system may be a physical entity for computing one or more large software projects. The method involves receiving one or more of an input data and an iteration data from a data repository. The one or more input data may be one or more of a desktop data, a network data, an external feed data and/or a knowledge base data.

The received one or more input data is transformed into a predefined format compatible with an inference generator. The transformation is performed at a data transformer based on one or more data transformation rules. The transformed one or more input data and the iteration data is analyzed at an analyzer, based on one or more pre-defined rules associated with a rule engine. The step of analysis may comprise identifying one or more patterns in the transformed one or more input data, quantifying the transformed one or more input data, and extracting one or more insights from the transformed one or more input data.

A result associated with an inference is generated at the inference generator, from the analyzed one or more input data and the iteration data. The result associated with the inference is generated based on one or more of automation rules and/or collaboration rules. The generated inference may be one of a positive or a negative. When the generated inference is positive, one or more workflow processes associated with a customer service system and/or an enterprise is simulated at an optimization engine, through one or more graphical processors. The result of the inference generator and an output of the optimization engine are checked against the one or more workflow processes. The result of the inference generator and the output of the optimization engine may be stored at the data repository.

In another aspect, a system process optimizer is disclosed. The system process optimizer comprises, a receiver, a data transformer, an analyzer, an inference generator, an optimization engine, a data repository and a rule engine. The receiver is configured to receive one or more data from the data repository. The one or more data may be received from one or more input sources and may be stored in the data repository. In some aspects, the one or more data may be received from the one or more computing devices for processing at the system process optimizer. The one or more input data may be, but not limited to desktop data, a network data, an external feed data and/or a knowledge base data.

The data transformer is configured to transform the one or more input data into a pre-defined format compatible with the inference generator. The data transformer is configured to perform transformation based on one or more data transformation rules. In some aspects, the input data may be transformed into a human readable format or any other format readable by computing machines. The analyzer is configured to analyze the transformed one or more input data and the iteration data based on one or more predefined rules associated with the rule engine. The step of analysis may be performed by identifying one or more patterns on the transformed one or more input data, quantifying the transformed one or more input data and extracting one or more insights from the transformed one or more input data.

The inference generator may be configured to generate a result associated with an inference from the analyzed one or more input data and the iteration data, based on the one or more insights. The result associated with an inference is also generated based on one or more of automation rules and/or collaboration rules. The generated inference may be either positive or negative. If the generated inference is positive, the optimization engine is configured to simulate one or more workflow processes associated with a customer service system. The inference generator may be configured to check the result of the inference generator and an output of the optimization engine against the one or more workflow processes. The inference generator may perform the check periodically. The result of the inference generator and the output of the optimization engine may be stored at the data repository.

In yet another aspect, a non-transitory computer readable storage medium to optimize system process is disclosed. The computer readable storage medium stores computer executable instructions to receive one or more of an input data and an iteration data from a data repository. The one or more input data may be one or more of a desktop data, a network data, an external feed data and/or a knowledge base data.

The received one or more input data is transformed into a predefined format compatible with an inference generator. The transformation is performed at the data transformer based on one or more data transformation rules. The transformed one or more input data and the iteration data is analyzed at an analyzer, based on one or more pre-defined rules associated with a rule engine. The analysis comprises identifying one or more patterns in the transformed one or more input data, quantifying the transformed one or more input data, and extracting one or more insights from the transformed one or more input data.

A result associated with an inference is generated at the inference generator, from the analyzed one or more input data and the iteration data. The result associated with the inference is generated based on one or more of automation rules and/or collaboration rules. The generated inference may be one of a positive or a negative. When the generated inference is positive, one or more workflow processes associated with the customer service optimization is simulated at the optimization engine, through a graphical processor. The result of the inference generator and the optimization engine are checked against the one or more workflow processes. The result of the inference generator and the optimization engine may be stored at the data repository.

The method, the system and/or the non-transitory computer readable storage medium disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one or more embodiments.

FIG. 2 is a block diagram, illustrating a system process optimizer, according to one or more embodiments.

FIG. 3 is a flow diagram, illustrating a method to optimize one or more workflow processes associated with a customer service environment, according to one or more embodiments.

FIG. 4 is a process flow diagram, illustrating a method to optimize one or more workflow processes associated with a customer service environment, according to one or more embodiments.

FIG. 5 is a block diagram, illustrating components associated with a system process optimizer, according to one or more embodiments.

FIG. 6 is a block diagram, illustrating components a data collection layer, associated with a customer service process optimization system, according to one or more embodiments.

FIG. 7 is an architecture diagram, illustrating desktop data capture mechanism system, according to one or more embodiments.

Other features of the present embodiments will be apparent from the accompanying drawings and from the detailed description that follows.

### DETAILED DESCRIPTION

Example embodiments, as described below, may be used to provide a method, a system optimizing system process in a service environment. Although the present embodiments have been described with reference to specific example embodiments, it will be evident that various modifications and changes may be made to these embodiments without departing from the broader spirit and scope of the various embodiments.

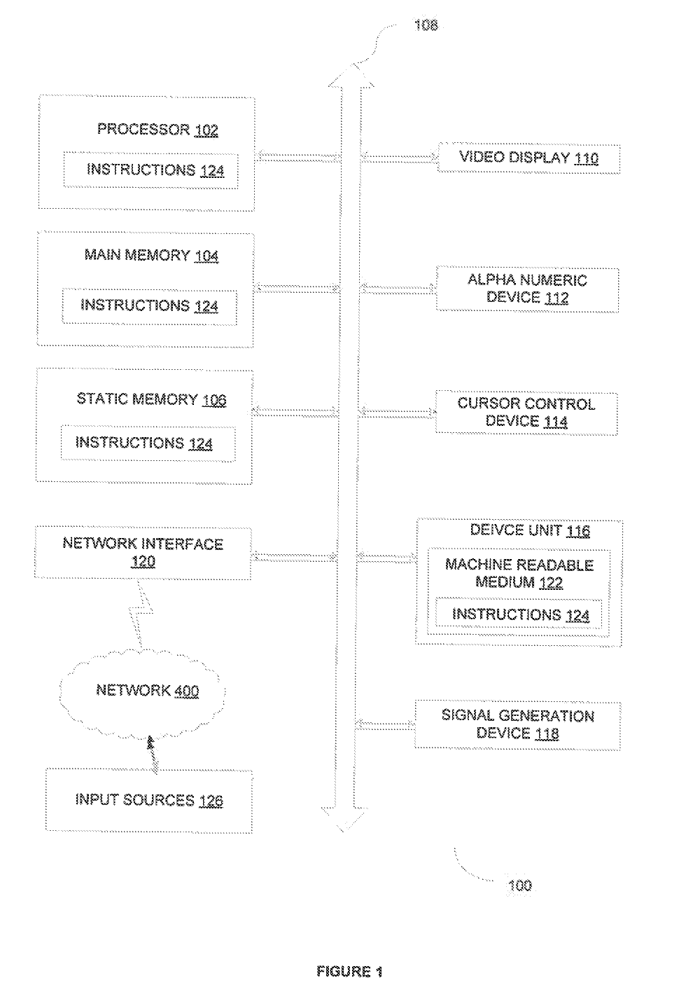

FIG. 1 is a diagrammatic representation of a data processing device capable of processing a set of instructions to perform any one or more of the methodologies herein, according to one embodiment. FIG. 1 shows a diagrammatic representation of machine and/or the data processing device in the example form of a computer system 100 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker) and a network interface 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104 and/or within the processor 102 during execution thereof by the computer system 100, the main memory 104 and the processor 102 also constituting machine-readable media.

The instructions 124 may further be transmitted and/or received over a network 400 via the network interface 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

A data repository may store information to optimize one or more system processes. In one or more embodiments, information may be related to one or more workflow processes associated with a customer service system. The data repository may store information including but not limited to domain knowledge and/or ontology required through solution deployment, one or more historical recommendations and solutions, and implementation of solutions.

In one or more embodiments, input sources 126 may be one or more of network sources and/or external sources. The network sources may be configured to provide information transmitted by one or more computing devices within a network. The information transmitted by the network sources may be, but not limited to information of one or more servers, routers and switches, capable of transmitting notifications and/or alerts associated with the status of the network sources. The one or more computing devices may be further configured to transmit network component information such as status of one or more network cablings, payment gateways and other components of the network.

In one or more embodiments, the external sources may be configured provide knowledge information. The knowledge information may be, but not limited to a domain knowledge and/or an ontology acquired through solution deployment. The external sources may also act as a repository of one or more recommendations and solutions suggested for previously recorded incidents, and real-time and near real-time inputs from implementation of the one or more recommendations and solutions.

Exemplary embodiments of the present disclosure provide a method and a system to optimize system processes in a service environment. The method may include receiving one or more of an input data and an iteration data from a data repository. The one or more input data may be one or more of a desktop data, a network data, an external feed data and/or a knowledge base data.

The received one or more input data may be transformed into a predefined format compatible with an inference generator. The transformation may be performed at the data transformer based on one or more data transformation rules. The transformed one or more input data and the iteration data may be analyzed at an analyzer, based on one or more pre-defined rules associated with a rule engine. The analysis may comprise identifying one or more patterns in the transformed one or more input data, quantifying the transformed one or more input data, and extracting one or more insights from the transformed one or more input data.

A result associated with an inference is generated at the inference generator, from the analyzed one or more input data and the iteration data. The result associated with the inference is generated based on one or more of automation rules and/or collaboration rules. The generated inference may be one of a positive or a negative. When the generated inference is positive, one or more workflow processes associated with the customer service environment may be simulated at the optimization engine, through a graphical processor. The result of the inference generator and the optimization engine may be checked against the one or more workflow processes. The result of the inference generator and the optimization engine may be stored at the data repository. In one or more embodiments, the result of the inference generator and the optimization engine may be checked at the inference generator.

In one or more embodiments, the one or more workflow processes may be user actions and/or processes of one or more applications associated with the customer service environment.

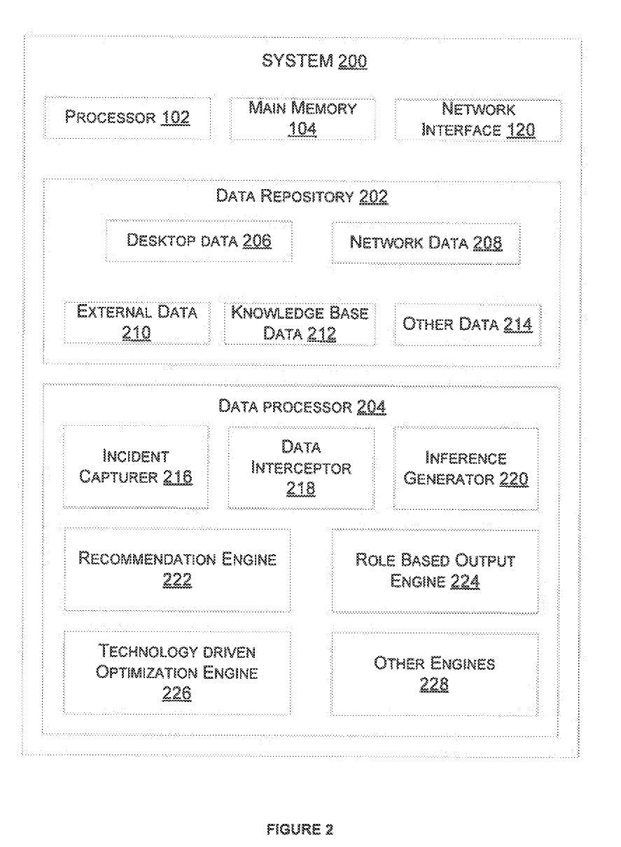

FIG. 2 is a block diagram, illustrating a system process optimizer 200, according to one or more embodiments. The system process optimizer 200 may comprise a processor 102, a main memory 104 and a network interface 120. The system process optimizer 200 may further comprise a data repository 202 and a data processor 204. In one or more embodiments, the system process optimizer 200 may be implemented in a variety of computing systems, such as laptop computer, a desktop computer, a notebook, a workstation, a mainframe computer, a server, a network server, a mobile device and the like.

In one or more embodiments, the data repository 202 may be configured to store one or more data received from one or more computing devices. The one or more data may be, but not limited to a desktop data 206, a network data 208, an external data 210, a knowledge base data 212, and/or other data 214.

The desktop data 206 may be one or more metadata. The one or more metadata may be, but not limited to one or more events such as mouse clicks and key strokes from one or more applications used by one or more users associated with a customer service environment and/or an enterprise. The enterprise may be a large organization associated with one or more software projects. The software projects may be associated with customer service processes. The network data 208 may be, but not limited to information transmitted by the one or more computing devices over a computer network. In some embodiments, the network data 208 may also be, but not limited to information of one or more network devices such as servers, routers and switches, capable of transmitting notifications and/or alerts associated with the status of the one or more network devices. The one or more computing devices may be further configured to transmit network component information such as status of one or more network cablings, payment gateways and other components of the computer network.

The external data 210 may be, but not limited to information passed on as feed from one or more external sources such as a social media (Facebook, Twitter and the like), and an Internet of Things (IoT). The external data 210 may further comprise information of one or more user computing devices accessed by one or more users. The one or more users may be associated with the customer service environment over a computer network.

The knowledge base data 212 may be, but not limited to information captured in a knowledge base such as a domain knowledge and an ontology acquired through deployment of one or more solutions.

In one or more embodiments, the other data 214 may be an iteration data. In another embodiment, the other data may be a temporary data used for optimization of one or more workflow processes associated with a customer service environment. The iteration data may be one or more of a recommendation suggested for previously recorded incidents, pattern recognized from data, analyzed data, sorted data, sanitized data, and/or a real time and a near real-time inputs from implementation of the one or more recommendations. In one or more embodiments, the iteration data may be one or more data generated after implementation of the one or more recommendations. The other data 214 may also include miscellaneous forms of data generated in association with a customer service environment.

In one or more embodiments, the data processor 204 may comprise, an incident capturer 216, a data interceptor 218, an inference generator 220, a recommendation engine 222, a role based output engine 224, a technology driven optimization engine 226, and other engines 228.

The incident capturer 216 may be configured to capture the desktop data 206. The data interceptor 218 may be configured to capture one or more of the network data 208, the external data 210 and/or knowledge base data 212. The data interceptor 218 may be further configured to capture one or more user actions and a system usage data from one or more computing devices used by one or more customer service staff. The incident capturer 216 may be deployed non-intrusively as a background window service at a desktop/computing systems of a customer service environment or an enterprise. In one or more embodiments, at least one of the incident capturer 216 and the data interceptor 218 may be configured to receive the iteration data.

In one or more embodiments, the one or more data captured at the incident capturer 216 and the data interceptor 218 may be merged and/or combined into a single format. The merge of the one or more input data is essentially to make sure every data captured from multiple sources are available in one format or as one data unit. The merger of data or availability of data in a single format may have multiple advantages including but not limited to reduced data processing time. The merged one or more data may be stored at a data store.

In one or more embodiments, the one or more data captured by the incident capturer 216 and the data interceptor 218 may be transformed to a predefined format compatible with the inference generator 220. The transformation may be performed based on one more data transformation. In one or more embodiments, the one or more data may be transformed into a format interpreted by human reading through a user interface at a node coupled to a computer network.

The inference generator 220 may be configured to receive the transformed one or more input data from at least one of the incident capturer 216 and/or data interceptor 218. The inference generator 220 may be further configured to analyze the transformed one or more input data and the iteration data.

In one or more embodiments, the inference generator 220 may be configured to check sufficiency of the one or more data for processing.

In one more embodiments, the analysis of the transformed one or more input data may comprise one or more of, but not limited to a quantification, a pattern recognition and an insights derivation. The quantification may involve identifying and grouping transformed one or more input data. The pattern recognition may involve identification of one or more patterns in the transformed one or more input data. The insight extraction may involve extraction of one or more insights from the transformed one or more input data.

The inference generator 220 may be further configured to generate a result associated with an inference. The inference may be generated based on one or more automation rules, one or more insights, analytics, human inputs, and real-time feed from the computer network. The generated inference may be one or more of a positive or a negative. In one or more embodiments, the one or more automation rules may be dependent on customer service environment. Different automation rules may be applied for different enterprises or customer service environments.

The generated result may comprise the one or more data and any other information associated with the one or more data which is readable by a computing machine. In one or more embodiments, the result may comprise the inference generated by the inference generator.

In one or more embodiments, if the inference is negative, the result of the inference generator may be fed back as input to the system process optimizer 100 of the customer service environment.

The recommendation engine may be configured to receive the insights and inference from the inference generator and provide one or more recommendations based the insights and the inference. The one or more recommendations may be a suggestion to a user or a computing system to pick one or more candidates for optimization. The one or more recommendations may be used for taking necessary actions for enhancing customer experience and improve operational efficiencies of the customer service environment.

The technology driven optimization engine 226 may be configured to optimize one or more workflow processes associated with the customer service process. The optimization may include one or more of, but not limited to automation, solution modification involving cognitive learning and/or other advanced solutions.

In one or more embodiments, one or more outcomes of the technology driven optimization of the one or more recommendations may be measured on a periodic basis. The role based output engine 224 may be configured to display the one or more outcomes, on a user interface of a computing system associated with the customer service environment.

In one or more embodiments, the role based output engine 224 may be configured to provide role based dashboard, which provides personalized view of one or more analyzes data, recommendations and consolidated view of the computer network.

In one or more embodiments, the one or more outcome and the one or more recommendations may be fed back along with the result of the inference generator 220, by storing them in the data repository 202, which constitutes the iteration data. The one or more outcomes and the one or more recommendations may be used to enhance an accuracy of the optimization.

In one or more embodiments, the system 100 captures one or more actions of users such as managers and/or supervisors to generate intelligence repository. The intelligence repository may help with automated recommendations and actions for future scenarios, similar to the optimized one or more workflow processes.

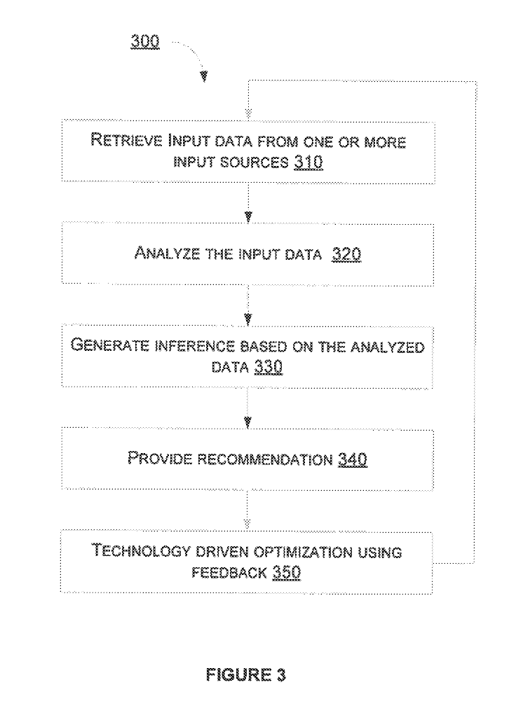

FIG. 3 is a flow diagram, illustrating a method to optimize one or more workflow processes associated with a customer service environment, according to one or more embodiments.

In one or more embodiments, one or more input data may be retrieved from a data repository, over a computer network, as in step 310. The one or more data may be, but not limited to a desktop data, a network data, an external data, a knowledge base data, and/or other data.

The desktop data may be one or more metadata. The one or more metadata may be, but not limited to one or more events such as mouse clicks and key strokes from one or more applications used by one or more customer service staff. The network data may be, but not limited to information transmitted by the one or more computing devices in a network. In some embodiments, the network data may also be, but not limited to information of one or more network devices such as servers, routers and switches, capable of transmitting notifications and/or alerts associated with the status of the one or more network devices. The one or more computing devices may be further configured to transmit network component information such as status of one or more network cablings, payment gateways and other components of the network.

The external data may be, but not limited to information passed on as feed from one or more external sources such as a social media (Facebook, Twitter and the like), and an Internet of Things (IoT). The external data may further comprise information of one or more user computing devices accessed by one or more users.

The knowledge base data may be, but not limited to information captured in a knowledge base such as a domain knowledge and an ontology acquired through deployment of one or more solutions in the customer service environment.

In one or more embodiments, the other data may be an iteration data. In another embodiment, the other data may be a temporary data. The iteration data may be one or more recommendations suggested for previously recorded incidents, and/or a real time and a near real-time inputs from implementations of the one or more recommendations.

In another embodiment, the one or more input data may be received from one or more computing devices associated with the customer service environment, over a computer network.

The one or more input data may further be, but not limited to one or more user actions and/or a system usage data from one or more computing devices used by one or more customer service staff.

The one or more data may be received at an incident capturer and a data interceptor of a customer service system. The received one or more data may be merged to form a single set of data. The merged one or more data may be transformed to a predefined format. The transformation may be performed based on one more data transformation rules. In another embodiment, the one or more data may be transformed into a format interpreted by humans.

For example, if the one or more input data contains ‘Ctrl’ key followed by next record with ‘C’ key, then the one or more input data may be transformed and/or converted to a ‘Copy Paste Event’. Similarly, if the one or more data contains an software application URL ‘Application 1’ followed by the next record ‘Application 2’, then the one or more data may be transformed into a ‘app switch event’.

The transformed one or more input data and the iteration data may be analyzed at an inference generator, as in step 320. In one more embodiments, the analysis of the transformed one or more input data may comprise one or more of, but not limited to a quantification, a pattern recognition and an insights derivation.

In one or more embodiments, the quantification may involve identifying and grouping of transformed one or more input data. The pattern recognition may involve identification of one or more patterns in the transformed one or more input data. The insight extraction may involve extraction of one or more insights from the transformed one or more input data.

One or more inferences may be generated based on the analysis of the transformed one or more input data, as in step 330. The inference may be generated based on one or more automation rules, one or more insights, an analytics, human inputs, and a real-time feed from the network. The generated inference may be at least one of a positive or a negative.

Based on the generated inference, one or more recommendations may be provided by a recommendation engine, as in step 340. In one or more embodiments, the positive inference indicates that at least one process associated with the one or more input data may be optimized. The negative inference may indicate that the at least one process associated with the one or more input data is already optimized and/or no actions may be required.

The recommendation engine may be configured to receive the insights and inference from the inference generator and provide one or more recommendations based the insights and the inference. The one or more recommendations may be used for taking necessary actions for enhancing customer experience and improve operational efficiencies of one or more processes associated with an enterprise.

A technology driven optimization may be performed to optimize a process flow or solutions of the customer service process. The technology driven optimization may comprise one or more of, but not limited to an automation, a solution modification involving cognitive learning and/or other advanced solutions known in the art.

In one or more embodiments, one or more outcomes of the technology driven optimization of the one or more recommendations may be measured on a periodic basis. The one or more outcomes may be displayed on a role based output engine. The one or more outcomes may be, but not limited to an automation script and/or an improved knowledge base etc. The measurement may be carried by, but not limited to calculating average request handling time per agent.

In one or more embodiments, the one or more outcomes and the one or more recommendations may be fed back to the customer service environment, by storing them in the data repository, which constitutes the iteration data. The one or more outcomes and the one or more recommendations may be used to enhance an accuracy of the optimization.

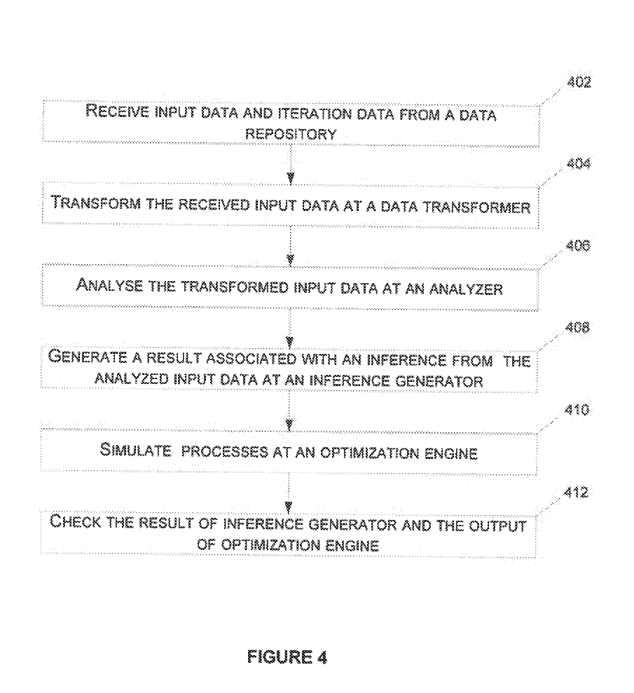

FIG. 4 is a process flow diagram, illustrating a method to optimize one or more workflow processes associated with a customer service environment, according to one or more embodiments.

In one or more embodiments, the one or more workflow processes may be a system processes of the customer service environment. The one or more workflow process may be, but not limited to one or more user actions associated with addressing the customer request in the customer service environment. For example, the one or more user actions may be sequence of steps that a customer service staff may perform on a computing system to address a request from a customer.

In one or more embodiments, one or more input data and an iteration data may be received from a data repository, over a computer network, as in step 402. The one or more data may be, but not limited to a desktop data, a network data, an external data, a knowledge base data, and/or other data.

The desktop data may be one or more metadata. The one or more metadata may be, but not limited to, one or more events such as mouse clicks and key strokes from one or more software applications used by one or more customer service staff. The network data may be, but not limited to information transmitted by one or more computing devices in a network. In some embodiments, the network data may also be, but not limited to information of one or more network devices such as servers, routers and switches, capable of transmitting notifications and/or alerts associated with the status of the one or more network devices. The one or more computing devices may be further configured to transmit network component information such as status of one or more network cablings, payment gateways and other components of the network.

The external data may be, but not limited to information passed on as feed from one or more external sources such as a social media (Facebook, Twitter and the like), and an Internet of Things (IoT). The external data may further comprise information of one or more user computing devices accessed by one or more users.

The knowledge base data may be, but not limited to information captured in a knowledge base such as a domain knowledge and an ontology acquired through deployment of one or more solutions/recommendations.

In one or more embodiments, the iteration data may be one or more recommendations suggested for previously recorded incidents, and/or real time and near real-time inputs from implementations of the one or more recommendations.

In another embodiment, the one or more input data may be received from one or more computing devices, over a computer network.

The one or more input data may further be, but not limited to one or more user actions and a system usage data from one or more computing devices used by one or more customer service staff.

The one or more data may be received at an incident capturer and a data interceptor of a customer service environment. In another embodiment, the one or more data may be received at any device or a system which is capable of receiving data. The received one or more data may be merged to form a single set of data.

The one or more data may be transformed at a data transformer, into a predefined format compatible with an inference generator, as in step 404. The transformation may be performed based on one more data transformation rules. In another embodiment, the one or more data may be transformed into a format interpreted by humans. The transformed one or more input data and the iteration data may be analyzed at an analyzer, as in step 406. The analysis of the transformed one or more input data may be performed based on one or more predefined rules associated with a rule engine.

In one more embodiments, the analysis of the transformed one or more input data may comprise one or more of, but not limited to a quantification, a pattern recognition and an insights derivation. The quantification may involve identifying and grouping of transformed one or more input data. The pattern recognition may involve identification of one or more patterns in the transformed one or more input data. The insight extraction may involve extraction of one or more insights from the transformed one or more input data.

A result associated with an inference may be generated at an inference generator, based on the analysis of the transformed one or more input data, as in step 408. The result associated with the inference may be generated based on one or more automation rules, one or more insights, analytics, human inputs, and a real-time feed from the network. The generated inference may be at least one of a positive or a negative.

The generated result may comprise the one or more data and any other information associated with the one or more data which is readable by a computing machine. In one or more embodiments, the result may comprise the inference generated by the inference generator.

In one or more embodiments, if the inference is negative, the result of the inference generator may be fed back as input to the customer service environment.

The one or more insights and inference may be received from the inference generator at the recommendation engine to provide one or more recommendations based the insights and the inference. The one or more recommendations may be a suggestion to a user or a computing system to pick one or more candidates for optimization. The one or more recommendations may be used for taking necessary actions for enhancing customer experience and improve operational efficiencies of a customer service process.

One or more processes associated with the customer service system may be simulated at an optimization engine, when the generated inference is the positive, as in step 410. In one or more embodiments, the one or more processes associated with the customer service environment may be simulated through one or more processors and/or one or more graphical processors. In one or more embodiments, the one or more processes may be the workflow process associated with the customer service system.

In one or more embodiments, a technology driven optimization may be performed on the one or more processes if the inference is the positive. One or more outcomes of the technology driven optimization may be measured on a periodic basis. The one or more outcomes may be displayed on a dashboard of a role based output engine.

In one or more embodiments, the technology driven optimization may be performed to optimize a process flow or solutions in a customer service environment. The technology driven optimization may include one or more of, but not limited to automation, solution modification involving cognitive learning and/or other advanced solutions.

The negative inference may indicate that the at least one process associated with the one or more input data is already optimized and/or no actions may be required.

The result of the inference generator and/or an output of the optimization engine may be checked against the one or more processes, as in step 412. The step of checking comprises analyzing the impact of optimization of the one or more processes of the customer service system.

In one or more embodiments, the one or more outcomes and the one or more recommendations may be fed back to the customer service environment, by storing them in the data repository, which constitutes the one or more input data. The one or more outcomes and the one or more recommendations may be used to enhance an accuracy of the optimization.

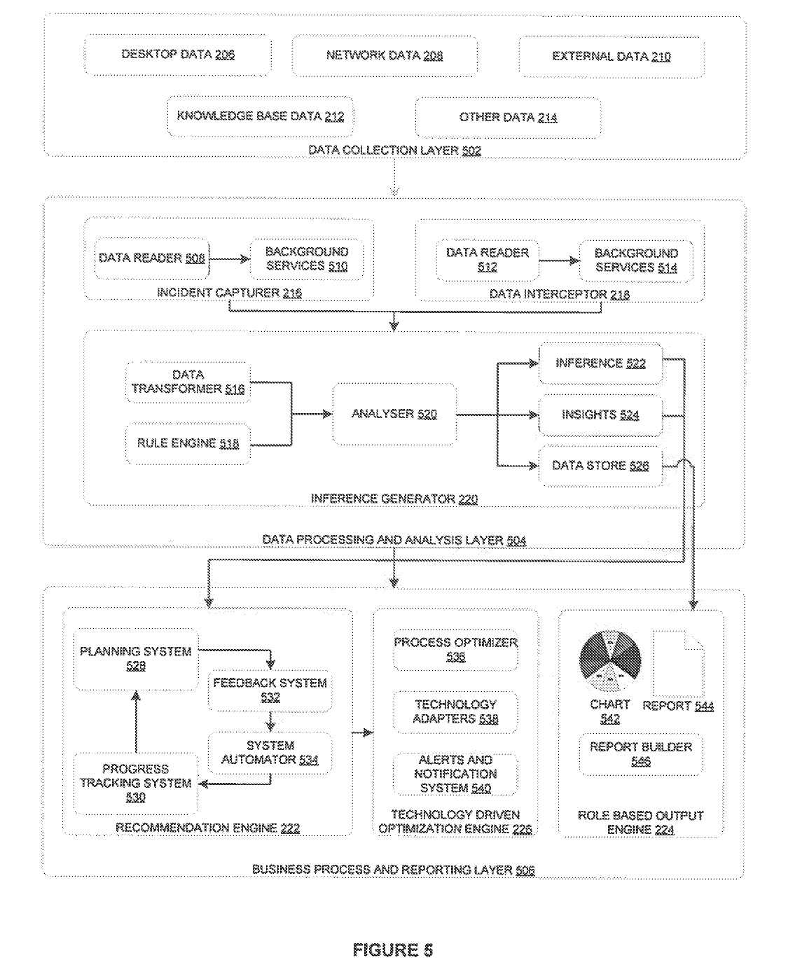

FIG. 5 is a block diagram, illustrating components associated with a system process optimizer, according to one or more embodiments.

In one or more embodiments, the system process may be one or more workflow processes or one or more customer service processes associated with a customer service environment.

In one or more embodiments, the system process optimizer may comprise, a data collection layer 502, a data processing and analysis layer 504 and a business process and reporting layer 506. The data collection layer 502, the data processing layer 504 and the business process and reporting layer 506 may be communicatively coupled to each other over a computer network.

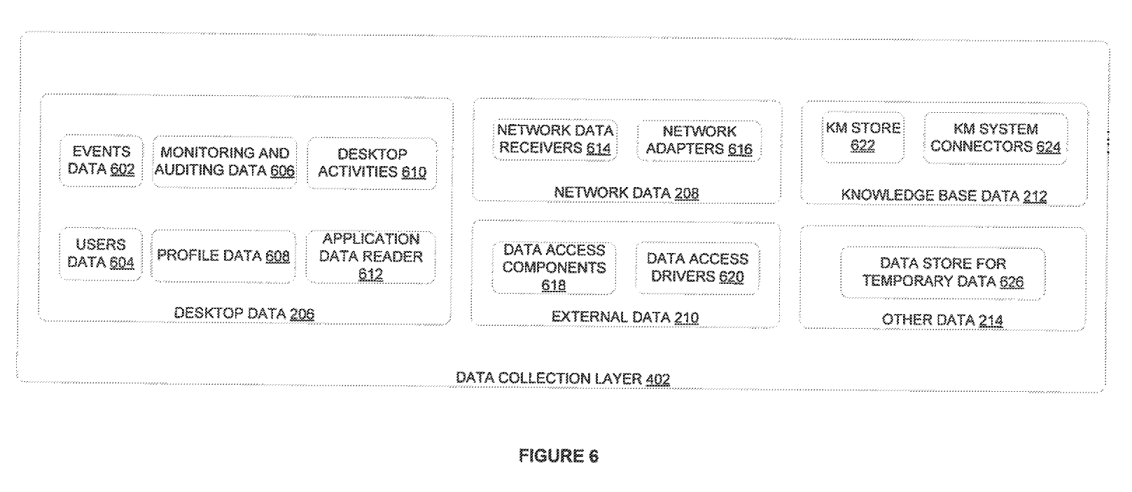

In one or more embodiments, the data collection layer may comprise a desktop data 206, a network data 208, an external data 210, a knowledge base data 212 and other data 214. The data collection later is described in detail in FIG. 6.

In one or more embodiments, the data processing and analysis layer 504 may comprise an incident capturer 216, a data interceptor 218 and an inference generator 220. The incident capturer 216 may comprise a data reader 508 and a background services 510. The data interceptor 218 may comprise a data reader 512 and a background services 514. In one or more embodiments, the inference generator 220, may comprise a data transformer 516, a rule engine 518, an analyzer 520, an inference(s) 522, an insight(s) 524 and a data store 526.

In or more embodiments, the business process and reporting layer 506 may comprise, a recommendation engine 222, a technology driven optimization engine 226 and a role based output engine 224. In one or more embodiments, the recommendation engine may comprise, a planning system 528, a progress tracking system 530, a feedback system 532 and a system automator 534.

In one or more embodiments, the technology driven optimization engine may comprise process optimizer 536, a technology adapter(s) 538, and alerts and notification system 540. In one or more embodiments, the role based output engine 224 may comprise a chart 542, a report 544 and a report builder 546.

In one or more embodiments, the data processing and analysis layer 504 may be configured to receive one or more input data from the data collection layer 502. The incident capturer 216 may be configured to receive the desktop data 206. The data interceptor 218 may be configured to receive the network data 208, the external data 210, the knowledge base data 212 and the other data 214. The incident capturer 216 and the data interceptor 218 may not be limited to above said receiving capability. The incident capturer 216 may not be limited to receive only the desktop data and the data interceptor 218 may be configured to receive desktop data as well.

The data reader 508 and 512 associated with the incident capturer 216 and data interceptor 218 may be configured to read/receive the one or more data from the data collection layer 502. The data reader 508 and 512 may be running and/or deployed non-intrusively as background services 510 and 514, at the computing systems used by one or more customer service staff.

The inference generator 220 may be configured to receive the one or more data from the incident capturer 216 and the data interceptor 218. The received one or more data may be consolidated/merged by the inference generator 220.

In one or more embodiments, the data transformer 516 may be configured to transform the one or more data. The one or more data may be transformed into a pre-defined format compatible with the inference generator 220. The analyzer 520 may be configured to analyze the transformed one or more input data, based on one or more data transformation rules associated with the rule engine 518.

The analyzer 520 associated with the inference generator 220 may be further configured to generate the inference(s) 522 and the insight(s) 524 from the analyzed one or more input data, based on one or more automation rules. The analyzer 520 may further store the analyzed one or more input data in a data store 526. The inference(s) 522 and the insight(s) 522 may be transferred to the business process and reporting layer 506. In one or more embodiments, the inferences(s) 522 may be a positive or a negative.

In one or more embodiments, the recommendation engine 222 is configured to recommend whether one or more processes associated with the one or more input data may be optimized or not. If the inference(s) is positive, the recommendation engine 222 may provide one or more recommendations. The one or more recommendations may be a suggestion to a user and/or a computing system to pick one or more candidates for optimization. The candidates for optimization may be chosen from one or more processes associated with the one or more data of the customer service process. In one or more embodiments, the one or more processes may be one or more customer service process. The one or more recommendations may be used for taking necessary actions for enhancing customer experience and improve operational efficiencies.

The planning system 528 may be configured for processing one or more generated inferences. The planning system 528 may further comprise a data store for the inferences and may generate timely events for processing the inferences.

The progress tracking system 530 may be configured receive output from the feedback system 532 about changes made based on one or more recommendations and its result. The system automator 534 may be configured to simulate the one or more processes associated with the customer service environment when the generated inference is the positive.

The progress tracking system 530 may be configured to improve the one or more processes that have been optimized, by checking the result of the inference generator 220 and the feedback system 532.

The technology driven optimization engine 226 may be configured to receive output of the recommendations engine 222. The process optimizer 536 may be configured to optimize the one or more processes of the customer service system based on one or more technology provided by the technology adapters 538 for directly making changes to the one or more processes based on the result of the inference generator 220 and the recommendation engine 222.

In one or more embodiments, the output of the inference generator 220, the recommendation engine 222 and the technology driven optimization engine 226 may be stored at a data repository along with the one or more data and the one or more processes associated with the one or more data. The alert and notification system 540 may configure alerts and notifications based on the output of the recommendation engine 222.

In one or more embodiments, the role based output engine 224 may be configured to provide role based dashboard, which provides personalized view of one or more of analyzed data, recommendations and consolidated view of a network. The report builder 546 may be configured to generate one or more charts 542 and one or more reports 544. The role based output engine 224 may further provide one or more out of the box reports and may be configured to have capability to create reports based on one or more data provided by the inference generator 220.

FIG. 6 is a block diagram, illustrating components of a data collection layer, associated with a system process optimizer, according to one or more embodiments.

In one or more embodiments, the data collection layer 502 may be configured to receive one or more input data from one or more computing devices, communicatively coupled to the data collection layer 502 and/or a customer service environment over a computer network. The data collection layer 502 may comprise a desktop data 206, a network data 208, an external data 210, a knowledge base data 212 and other data 214. The desktop data 206 may comprise an event(s) data 602, a user(s) data 604, a monitoring and auditing data 606, a profile data 608, a desktop activities 610 and an application data reader 612. The application data reader 612 may be configured to receive data related to one or more applications running on one or more computing devices of one or more staff of the customer service environment.

In one or more embodiments, the event(s) 602 data may be one or more data associated with the one or more processes of the customer service environment. The user(s) data 604 may be one or more data associated with one or more users. The one or more users may be end users who are served by the one or more customer service staff. The one or more users may be connected to the customer service environment through one or more computing devices, over a computer network.

In one or more embodiments, the monitoring and auditing data 606 may be, but not limited to system change logs, system events and so on. The profile data 608 may be one or more data related to one or more users associated with the customer service environment or an enterprise. The desktop activity data 610 may be one or more events such as mouse clicks and key strokes from one or more applications used by the one or more customer service staff. The application data reader 612 may be configured to capture one or more application data of the customer service environment, wherein one or more applications may be used by the one or more staff of the customer service environment.

In one or more embodiments, the network data 208 may be associated with a network data receivers 614 and a network data adapters 616. The network data receivers 614 may be configured receive an information transmitted by the one or more computing devices in a network. In some embodiments, the network data receivers 614 may also be configured to receive an information of one or more network devices such as servers, routers and switches, capable of transmitting notifications and/or alerts associated with the status of the one or more network devices. The one or more computing devices may be further configured to transmit network component information such as status of one or more network cablings, payment gateways and other components of a network.

In one or more embodiments, the network adapters 616 may be configured to collect one or more network data. In one or more embodiments, the external data 210 may be one or more data associated with a data access components 618 and a data access drivers 620. The data access components 618 may be configured to capture an information passed on as feed from one or more external sources such as a social media (Facebook, Twitter and the like), an Internet of Things (IoT), and information of one or more user computing devices accessed by one or more users. The data access drivers 620 may be configured to collect data from multiple and/or different sources.

In one or more embodiments, the knowledge base data 212 may be associated with KM (Knowledge Management) store 622, and KM system connectors 624. In one or more embodiments, the KM store 622 may be configured to store one or more knowledge base data, wherein the KM system connectors 624 may be configured to establish a connection with the KM store 622 over a computer network. The knowledge base data 212 may be, but not limited to information captured in a knowledge base such as a domain knowledge and an ontology acquired through deployment of one or more solutions.

The other data 214 may be associated with data store for temporary data 626. The data store 626 may be configured to store temporary data associated with customer service system. In one or more embodiments, the other data 214 may be an iteration data. The iteration data may be one or more recommendations suggested for previously recorded incidents, and/or real time and near real-time inputs from implementations of the one or more recommendations.

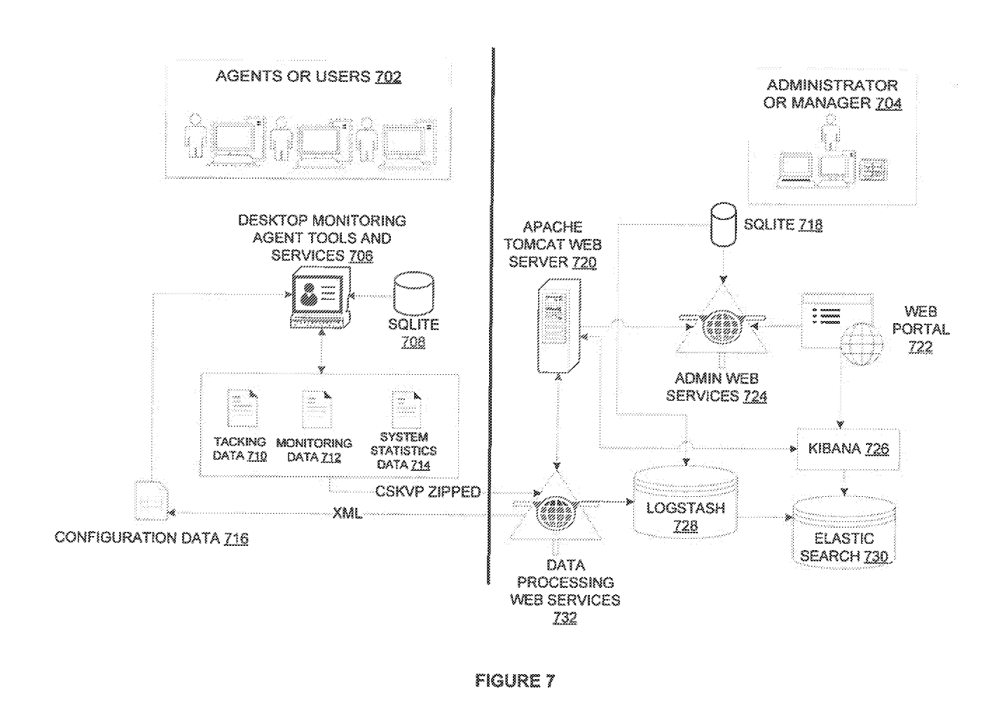

FIG. 7 is an architecture diagram, illustrating desktop data capture mechanism system, according to one or more embodiments.

In one or more embodiments, the desktop data capture mechanism system may comprise, an agents/users 702, a desktop monitoring agent tools and services 706, a SQLite database 708, a tracking data 710, a monitoring data 712, a system statistics data 714, a configuration data 716.

In one or more embodiments, the system may also comprise, an administrator or manager 704, an SQLite database 718, an Apache Tomcat server 720, a web portal 722, an admin web services 724, a Kibana™ tool 726, a Logstash™ database 728, an elastic search database 730, and a data processing web services 732. In one or more embodiments, one or more computing machines and/or components associated with the desktop data capture mechanism system may be implemented as a one or more client-server network environments.

In one or more embodiments, agents and/or users 702 may represent a part of the system which represents a desktop monitoring utility components. The desktop monitoring utility components may collect one or more data for reporting and analytics purpose. The reporting and analytics may be referred as a Data Management Analytics (DMA). The DMA may have a mechanism implemented to receive/fetch the one or more data from the DMA agents/users 702, which may be further extended to receive one or more raw data from any other systems

In one more embodiments, at desktops/computing systems of one or more user/agents, a Microsoft Installer (MSI) installer may be ran to install one or more desktop monitoring utilities. Any other installers, similar to MSI installer may be used in one or more discussed embodiments. The MSI installer may create a windows service which controls the one or more desktop monitoring utilities (a desktop monitoring exe file). One or more configuration data 716 needed for one or more services may be stored on one or more components associated with agents/users 702 in an XML format. The configuration data 716 may be received from data processing web services 732 to store at the desktop monitoring agent tools and services 706.

In one or more embodiments, when a desktop monitoring exe file is launched for a first time, the desktop monitoring exe file may perform a self-registration to register the one or more users/agents along with machine details of the one or more users/agents. The machine details may be, but not limited to mac id and user id. The machine details may be registered to uniquely record as one of the one or more users/agents.

After a successful registration, a combination of the user id and the mac id may be assigned as a unique key to the one or more users/agents and may be used for all future tracking. The desktop monitoring utilities (the desktop monitoring exe file) may keep on running on the one or more user/agent desktop at a configured frequency. All tracking data such as, but not limited to application in focus, a key press, and a mouse click etc. may be first recorded in a storage device and then may be configured to be pushed to the SQLite database 708. At the configured frequency, the tracking data from the SQLite database 708 may be analyzed.

In one or more embodiments, one or more L1 matrices may be calculated and the tracking data 710 along with the monitoring data 712 may be collected in data processing web services 732, but not limited to cskvp (Comma separated key value pair) format. The data in cskvp format may be then zipped and pushed via a data processing web services 732 call to a central processing server.

Describe system statistics data 714 may be one or more of, but not limited to information of usage of hardware resources over a certain period, changes to system configurations, system updates over a certain period etc.

In one or more embodiments, once the data is pushed to the central processing server, it may go through a standard Extraction, Transportation and Loading (ETL) processing at the Logstash™ 728 to load a raw data along with a merged configuration admin data to the elastic search data store 730. Reporting and dashboard may be provided by Kibana™ framework 726 which may read the data (indexed and merged event data) through one or more out of box APIs (e.g. GetIndexData with date-time based filtering, wherein index name may be ‘eventdata’). The reporting and dashboard provided by the Kibana™ framework 726 may be present in one or more configured layouts.

The data processing web service 732 may receive one or more zipped event data files, unzips it, and may fetch configuration data from an admin database. The data processing web service 732 may further merge event data and configuration data and may push the merged data to Logstash™ 728.

In one or more embodiments, for an Admin Portal, one or more basic “Forms Authentication” may be enabled through the web portal 722 and the admin web services 724. Forms Authentication may authenticate user access to admin portal. The admin portal may comprise a store of user credentials. Whenever a user access admin portal providing his/her credentials, then the provided credentials may be validated against the store. On validation success, the user gets access to the admin portal.

A ‘server.xml’ file associated with Apache Tomcat web server 720 may be updated with one or more configurations to enable a “JDBC Realm” based authentication with SQLite 718 at a backend. The JDBC Realm may be configured to use passwords encrypted using MD5 algorithm for digests.

In one or more embodiments, the admin portal may provide the ability to configure and set one or more master data for one or more users, applications, events, and also a URL data. The Admin portal may also provide future needs of whitelisting and blacklisting of applications and/or events as needed by one or more clients/customers.

In one or more embodiments, a method to optimize system processes (customer service processes) may comprise steps for data collection and storage, analysis of data by creating relation between the data collected, providing recommendations, optimizing the processes based on one or more recommendations, analyzing the data to check the impact of optimization.

In one or more embodiments, one or more input data from one or more internal sources and one or more external sources may be stored in a data repository associated with a centralized system, communicatively coupled over a computer network. The one more internal sources may be one or more computing devices in a customer service environment or an enterprise. The one or more external sources may be one or more computing devices in another customer service environment or another enterprise. The one or more data from the internal sources may contain information of usage of one or more devices and usage of applications installed on the one or more devices. The information may also comprise one or more activities/events performed by the application. Sample data from the one or more internal sources is provided in Table 1.

TABLE 1

| | User ID | | | |
|---|---|---|---|---|
| | User 01 | User 01 | User 01 | User 01 |
| Process | iexplore | chrome | chrome | chrome |
| Name | | | | |
| Application | //punitp341047d/ | 8181/secure/ | //www.youtube.com/ | //www.youtube.com |
| URL | dma-admin/ | Dashboard.jspa | watch?v=cvjSAyIs3BQ | |
| | index.html#/ | | | |
| | instanceconfig | | | |
| IP Address | 10.00.9200.16384 | 43.0.2357.124 | 43.0.2357.124 | 43.0.2357.124 |
| . | . | . | . | . |
| . | . | . | . | . |
| . | . | . | . | . |
| Mouse Left | MouseLClick | MouseLClick | MouseLClick | MouseLClick |
| Click | | | | |
| Count | 2 | 2 | 2 | 2 |

In one or more embodiments, the one or more input data from the external sources may be data from another computing system from another customer service environment or an enterprise. For example, a call data from another system may be the one or more data from external sources. Sample data from the one or more external sources is provided in Table 2.

TABLE 2

| User | Call | Call | Process | Dura- | Start | End |
|---|---|---|---|---|---|---|
| ID | ID | Type | Type | tion | Timestamp | Timestamp |
| User 01 | 1 | 1 | Billing | 400 | 2/5/16 | 2/5/16 |
| | | | Related | | 10:15 AM | 10:21 AM |
| User 02 | 2 | 1 | Billing | 500 | 2/5/16 | 2/5/16 |
| | | | Related | | 10:15 AM | 10:23 AM |
| User 03 | 3 | 1 | Billing | 270 | 2/5/16 | 2/5/16 |
| | | | Related | | 10:15 AM | 10:19 AM |
| User 04 | 4 | 1 | Billing | 310 | 2/5/16 | 2/5/16 |
| | | | Related | | 10:15 AM | 10:20 AM |
| User 05 | 5 | 2 | Activation | 510 | 2/5/16 | 2/5/16 |
| | | | Related | | 10:30 AM | 10:38 AM |
| User 06 | 6 | 2 | Activation | 550 | 2/5/16 | 2/5/16 |
| | | | Related | | 10:30 AM | 10:39 AM |
| User 07 | 7 | 2 | Activation | 600 | 2/5/16 | 2/5/16 |
| | | | Related | | 10:30 AM | 10:40 AM |
| User 08 | 8 | 2 | Activation | 490 | 2/5/16 | 2/5/16 |
| | | | Related | | 10:30 AM | 10:38 AM |
| User 09 | 9 | 3 | Number | 390 | 2/5/16 | 2/5/16 |
| | | | Portability | | 10:20 AM | 10:26 AM |
| User 10 | 10 | 3 | Number | 430 | 2/5/16 | 2/5/16 |
| | | | Portability | | 10:20 AM | 10:27 AM |

The one or more data received from multiple sources may be gathered at a data store or a data repository. The one or more data may be merged to form a logical data set. A sample merged logical data set is shown in Table 3. The logical data set may be arranged based on one or more pre-defined conditions, to identify one or more patterns. The pre-defined conditions may help to identify various information such as different processes, different applications or tools which are used by one or more users, a frequency of usage of the different applications, one or more activities/events performed on the different applications. These various information may be categorized under different bucket. One or more inferences may be generated based on the analysis of the one or more data as disclosed in one or more embodiments.

TABLE 3

| | UserID | | | | |
|---|---|---|---|---|---|
| | User 01 | User 01 | User 02 | User 03 | User 04 |
| CallID | 1 | 1 | 2 | 3 | 4 |
| CallType | 1 | 1 | 1 | 2 | 2 |
| Application | AHD | — | — | — | AHD |
| AppType | Ticketing | — | — | — | Ticketing |
| ProcessTitle | NA | — | — | — | NA |
| URLTitle | http://blrkecsdk06/ | — | — | — | http://blrkecsdk06/ |
| | CAisd/pdmweb5.exe | | | | CAisd/pdmweb5.exe |
| StartTimestamp | 2/5/16 | 2/5/16 | 2/5/16 | 2/5/16 | 2/5/16 |
| | 10:15 AM | 10:15 AM | 10:15 AM | 10:15 AM | 10:15 AM |
| EndTimestamp | 2/5/16 | 2/5/16 | 2/5/16 | 2/5/16 | 2/5/16 |
| | 10:21 AM | 10:21 AM | 10:23 AM | 10:19 AM | 10:20 AM |
| FocusDuration | 55 | — | — | — | 71 |
| Keystrokes | 0 | — | — | — | 46 |
| Mouseclicks | 12 | — | — | — | 18 |
| Ctrl-C | 0 | — | — | — | 1 |
| Ctrl-V | 0 | — | — | — | 0 |
| AltCallDrn | 430 | 430 | 425 | 250 | 275 |
| CallDuration | — | 430 | 425 | 250 | — |
| TotalKeystrokes | — | 214 | 231 | 99 | — |
| TotalMouseclicks | — | 88 | 114 | 101 | — |
| TotalCtrl-C | — | 3 | 6 | 3 | — |
| TotalCtrl-V | — | 5 | 5 | 3 | — |
| CommDuration | — | 135 | 197 | 0 | — |
| CommKeystrokes | — | 106 | 145 | 0 | — |
| CommMouseclicks | — | 8 | 13 | 0 | — |
| EntDuration | — | 135 | 118 | 133 | — |
| EntKeystrokes | — | 43 | 24 | 32 | — |
| EntMouseclicks | — | 57 | 75 | 76 | — |
| KMSDuration | — | 35 | 20 | 0 | — |
| KMSKeystrokes | — | 20 | 10 | 0 | — |
| KMSMouseclicks | — | 5 | 2 | 0 | — |
| TicketingDuration | — | 115 | 85 | 85 | — |
| TicketingKeystrokes | — | 45 | 52 | 57 | — |
| TicketingMouseclicks | — | 18 | 24 | 21 | — |
| OfficeDuration | — | 0 | 0 | 32 | — |
| OfficeKeystrokes | — | 0 | 0 | 10 | — |
| OfficeMouseclicks | — | 0 | 0 | 4 | — |
| CommCount | — | 2 | 3 | 0 | — |
| LyncCount | — | 0 | 3 | 0 | — |
| OutlookCount | — | 2 | 0 | 0 | — |
| CPUUtilization | — | 10 | 45 | 30 | — |
| MemoryUtilization | — | 40 | 46 | 20 | — |

On the one or more inferences, one or more pre-defined conditions is applied to determine and to recommend if any of the one or more processes may be optimized or not. These recommendations acts as one of the outputs of data analysis.

In one or more embodiments, the recommendations which are proposed by system process optimizer are implemented. In one or more embodiments, automation may be one of the ways of optimize one or more processes. The optimization may be achieved using a Smart User Environment (SE) tool. The Smart User Environment tool will help to automate the one or more processes which will reduce the time of user spent with customers to resolve one or more incidents reported at the customer service environment or a customer service system. Once optimization is implemented, a process among the one or more processes which has been optimized may be analyzed again to check an impact of the optimization.

In one or more embodiments, a method to optimize system processes is disclosed. For example, one or more users associated with an enterprise may be working on an incident, such as ticket resolution system. For example, the one or more users may be a customer service staff.

In one or more embodiments, the customer service staff may take more time to work on a ticket or an incident. In some cases, many customer service staffs may be taking more time to resolve an issue. In such cases, for an efficient execution of customer service, some of the processes associated with one or more incidents needs to be optimized. Automation of one or more processes may be one of the solutions. So, if an incident is reported at the customer service system, the customer service staff may not put his/her effort in resolution of the incident. Instead, the customer service system, automatically resolves, wherein the system by now would know how to resolve the incident, which may be a result of optimization performed by the method and system to optimize customer servicer process disclosed herein.

The method may include receiving one or more data from one or more computing devices. The one or more computing devices may be, but not limited to one or more user devices, associated with a customer service system, over a computer network. The one or computing devices mat be used by users or agents or customer service staffs. In some embodiment, the one or more computing device may be associated with a non-transitory computer readable storage medium.

In one or more embodiments, the customer service system may be configured to fetch the one or more data from a data repository configured to store the one or more data. The received one or more data may be transformed into a pre-defined format that is readable by one or more computing devices, based on one or more transformation rules. In another embodiment, a pre-defined format may be a format which is readable by humans.

In one or more embodiments, the one or more data may be merged to form a single format data, as the one or more computing devices may have different formats and may have been stored in different formats at the data repository.

In one or more embodiments, the transformed one or more data may be analyzed based on one or more data transformation rules associated with a rule engine. The analysis may include, but not limited to identifying one or more patterns in the transformed one or more input data, quantifying the transformed one or more input data, and extracting one or more insights from the transformed one or more input data.

In one or more embodiments, one or more insights and inferences may be generated based on the analysis of the one or more data. The generated inference may be either a positive or a negative. The positive inference may be, but not limited to ‘YES’, or binary ‘1’. The negative inference may be, but not limited to ‘NO’ or binary ‘0’.

In one or more embodiments, the inference is a recommendation that the system process optimizer provides whether one or more processes associated with one or more data may be optimized or not.

When the inference is negative, it may indicate that the one or more processes may not be optimized as it might be working at an optimal level. In another embodiment, the inference may be negative, which indicates that the one or more process might have already been optimized, which requires no further interventions. In one or more embodiments, when the inference is the positive, one or more user and/or customer service staff actions may be simulated and/or automated. The simulated/automated actions of the one or more user/customer service staff may be fed back to the system. When the incidents, similar to those which have been simulated, may be resolved based on the simulated/automated actions.

For example, consider the below sequence of steps. A customer service staff may open an incident ‘A’ through an application associated with computing device of the customer service staff, read through the description of the incident, open another application, copy data from the another application to the incident ‘A’ and close the incident ‘A’. So, the sequence of steps performed by the customer service staff may be recorded. When one or more incidents, similar to the incident ‘A’ comes into the system, the sequence of step performed by the customer service staff with respect to the incident ‘A’ may be replayed. If millions of incidents similar to the incident ‘A’ is reported at the system, the sequence of steps may be replayed. Since the recorded steps are performed by computing system, the speedy resolution is achieved.

The simulated actions of the one or more user/customer service staffs may be checked on periodic basis. In one or more embodiments, the method may be performed in an iterative manner, i.e., the one or more process may be optimized and fed back to the system for further optimization.

In one or more embodiments, values in Table 4 and Table 5 indicates one or more automation rules based on which an inference may be generated. If the data for at least one of one or more processes such as Copy and/or Paste, Typing, Thinking time, Switching between applications, and/or Number of application being referred is at least one of ‘high’ or ‘medium’, then the at least one process may be considered as a candidate for optimization and/or automation.

TABLE 4

| | | | | | Number of |
|---|---|---|---|---|---|
| Technology led | | | Think- | Switching | application |
| Automation | Copy/ | | ing | between | being |
| candidate | Paste | Typing | time | applications | referred |
| Conditions | High | High | High | High | High |
| 01 | | | | | |
| Conditions | Medium | Medium | Medium | Medium | Medium |
| 02 | | | | | |

TABLE 5

| Not a | | | | | Number of |
|---|---|---|---|---|---|
| candidate | | | Think- | Switching | application |
| for | Copy/ | | ing | between | being |
| Automation | Paste | Typing | time | applications | referred |
| Conditions | Low | Low | Low | Low | Low |
| 01 | | | | | |

In one or more embodiments, if the data for at least one of one or more processes such as Copy and/or Paste, Typing, Thinking time, Switching between applications, and/or Number of application being referred is ‘low’, then the at least one process may not be considered as a candidate for automation. In one or more embodiments, many such rules may be created and not limited to the above said one or more rules.

In one or more embodiments, Table 6, Table 7 and Table 8 indicates one or more data collected for one or more users and also indicates whether one or more processes such as, but not limited to ‘billing related’, ‘activation related’ and ‘number portability’ that may be candidates for optimization and/or automation. As disclosed above, the candidates for automation may be selected based on one or more automation rules.

TABLE 6

| | Billing Related | | | |
|---|---|---|---|---|
| | Users | | | |
| Problem Category | User 01 | User 02 | User 03 | User 04 |
| Actual Handling time | 400 | 500 | 270 | 310 |
| Expected Handling | 300 | 300 | 300 | 300 |
| time | | | | |
| Copy/Paste | Medium | High | Medium | High |
| Typing | High | High | High | High |
| Thinking time | High | High | Medium | High |
| Switching between | High | High | High | High |
| applications | | | | |
| Number of application | Medium | Medium | Medium | Medium |
| being referred | | | | |
| CPU Utilization | Average | Average | Average | Average |
| Memory Utilization | Average | Average | Above | Below |
| | | | Average | Average |
| Candidates for | Yes | Yes | Yes | Yes |
| Automation | | | | |

TABLE 7

| | Activation Related | | | |
|---|---|---|---|---|
| | Users | | | |
| Problem Category | User 05 | User 06 | User 07 | User 08 |
| Actual Handling time | 510 | 550 | 600 | 490 |
| Expected Handling | 500 | 500 | 500 | 500 |
| time | | | | |
| Copy/Paste | Medium | Medium | Medium | Medium |
| Typing | High | High | High | Medium |
| Thinking time | High | High | Low | Medium |
| Switching between | Medium | Medium | Medium | Medium |
| applications | | | | |
| Number of application | Medium | Medium | Medium | Medium |
| being referred | | | | |
| CPU Utilization | Average | Average | Average | Average |
| Memory Utilization | Average | Average | Below | Above |
| | | | Average | Average |
| Candidates for | Yes | Yes | Yes | Yes |
| Automation | | | | |

TABLE 8

Number Portability
Users

| Problem Category | User 09 | User 10 |
|---|---|---|
| Actual Handling time | 390 | 430 |
| Expected Handling | 400 | 400 |
| time | | |
| Copy/Paste | Low | Low |
| Typing | High | High |
| Thinking time | Low | Low |
| Switching between | Low | Low |
| applications | | |
| Number of | Low | Low |
| application being | | |
| referred | | |
| CPU Utilization | Average | Average |
| Memory Utilization | Average | Average |
| Candidates for | No | No |
| Automation | | |

In one or more embodiments, as illustrated in the Table 6, the Table 7 and the Table 8, processes associated with user 01, user 02, user 03, user 04, user 05, user 06, user 07 and user 08 were chosen by the system as candidates for optimization through automation. Post optimization of the processes, the data in Table 9 illustrates reduction in actual handling time of one or more processes associated with one or more users.

TABLE 9
Result - Post Optimization

| | | Actual | Expected |
|---|---|---|---|
| | | Handling | Handling |
| | Users | time | time |
| Billing Related | User 01 | 100 | 300 |
| | User 02 | 110 | 300 |
| | User 03 | 115 | 300 |
| | User 04 | 105 | 300 |
| Activation Related | User 05 | 250 | 500 |
| | User 06 | 255 | 500 |
| | User 07 | 245 | 500 |
| | User 08 | 255 | 500 |
| Number Portability | User 09 | 390 | 400 |
| | User 10 | 430 | 400 |

The tables presented herein are to be regarded in an illustrative rather than a restrictive sense.

In one or more embodiments, a system process optimizer is disclosed. The system process optimizer may comprise, a receiver, a data transformer, an analyzer, an inference generator, and an optimization engine. The receiver may be configured to receive one or more data from a data repository. The one or more data may be received from one or more input sources and may be stored in the data repository. In some embodiments, the one or more data may be received directly from the one or more computing devices for processing at the system process optimizer. The one or more embodiments, the one or more input data may be, but not limited to desktop data, a network data, an external feed data and/or a knowledge base data.

The data transformer may be configured to transform the one or more input data into a pre-defined format compatible with the inference generator. The data transformer may be configured to perform transformation based on one or more transformation rules. In some embodiments, the input data may be transformed into a human readable format or any other format which is readable by any computing machines. The analyzer may be configured to analyze the transformed one or more input data based on one or more predefined rules associated with a rule engine. The step of analysis may be performed by identifying one or more patterns on the transformed on or more input data, quantifying the transformed one or more input data and extracting one or more insights from the transformed one or more input data.

In one or more embodiments, the inference generator may be configured to generate a result associated with an inference from the analyzed one or more input data and/or the iteration data, based on one or more automation rules. The generated inference may be either positive or negative. If the generated inference is positive, the optimization engine may be configured to simulate one or more processes associated with a customer service system. The result of the inference generator and the output of the optimization engine may be stored at the data repository.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through one or more processors. These input and output operations may be performed by a processor. The medium readable through the one or more processors may be, for example, a memory, a transportable medium such as a CD, a DVD, a Blu-ray™ disc, a floppy disk, or a diskette. A computer program embodying the aspects of the exemplary embodiments may be loaded onto the one or more processors. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A method for optimizing workflow processes associated with a system, comprising:
receiving, by a system process optimizer device and from a data repository, at least one of input data or iteration data;
transforming, by the system process optimizer device, the received input data into a predefined format compatible with an inference generator, based on one or more data transformation rules;
analyzing, by the system process optimizer device, the transformed input data and the iteration data, based on one or more pre-defined rules associated with a rule engine;
generating, by the system process optimizer device, an inference from at least one of the analyzed input data or the iteration data, based on one or more automation rules, wherein the generated inference is one of a positive or a negative; and
simulating, by the system process optimizer device, one or more workflow processes when the inference is positive.

2. The method of claim 1, further comprising storing, by the system process optimizer device, the inference in the data repository.

3. The method of claim 1, wherein the input data comprises desktop data, network data, external feed data, or knowledgebase data.

4. The method of claim 1, further comprising:
identifying, by the system process optimizer device, one or more patterns in the transformed input data;
quantifying, by the system process optimizer device, the transformed input data; and
extracting, by the system process optimizer device, one or more insights from the transformed input data.

5. A system process optimizer device, comprising memory comprising programmed instructions stored in the memory and one or more processors configured to be capable of executing the programmed instructions stored in the memory to:
receive, from a data repository, at least one of input data or iteration data;
transform the received input data into a predefined format compatible with an inference generator, based on one or more data transformation rules;
analyze the transformed input data and the iteration data, based on one or more pre-defined rules associated with a rule engine;
generate an inference from at least one of the analyzed input data or the iteration data, based on one or more automation rules, wherein the generated inference is one of a positive or a negative; and
simulate one or more workflow processes when the inference is positive.

6. The system process optimizer device of claim 5, wherein the one or more processors are further configured to be capable of executing the programmed instructions stored in the memory to store the inference in the data repository.

7. The system process optimizer device of claim 5, wherein the input data comprises desktop data, network data, external feed data, or knowledgebase data.

8. The system process optimizer device of claim 5, wherein the one or more processors are further configured to be capable of executing the programmed instructions stored in the memory to:
identify one or more patterns in the transformed input data;
quantify the transformed input data; and
extract one or more insights from the transformed input data.

9. A non-transitory computer-readable medium having stored thereon instructions for configuring field programmable devices comprising executable code which when executed by one or more processors, causes the processors to perform steps comprising:
receiving, from a data repository, at least one of input data or iteration data;
transforming the received input data into a predefined format compatible with an inference generator, based on one or more data transformation rules;
analyzing the transformed input data and the iteration data, based on one or more pre-defined rules associated with a rule engine;
generating an inference from at least one of the analyzed input data or the iteration data, based on one or more automation rules, wherein the generated inference is one of a positive or a negative; and
simulating one or more workflow processes when the inference is positive.

10. The non-transitory computer-readable medium of claim 9, wherein the executable code when executed by the processors causes the processor to perform one or more additional steps comprising storing the inference in the data repository.

11. The non-transitory computer-readable medium of claim 9, wherein the input data comprises desktop data, network data, external feed data, or knowledgebase data.

12. The non-transitory computer-readable medium of claim 9, wherein the executable code when executed by the processors causes the processor to perform one or more additional steps comprising:
identifying one or more patterns in the transformed input data;
quantifying the transformed input data; and
extracting one or more insights from the transformed input data.
